(19) United States
(12) Patent Application Publication
(10) Pub. No.: US 2012/0113773 A1
(43) Pub. Date: May 10, 2012

(54) INFORMATION RECORDING DEVICE

(75) Inventors: Tatsuyuki MATSUO, Kobe-shi (JP); Masato ISHIO, Kobe-shi (JP); Tomoyuki KATO, Kobe-shi (JP); Atsushi YAMANAKA, Kobe-shi (JP); Keiichi TANAKA, Okazaki-shi (JP); Tomoyasu ISHIKAWA, Nagoya-shi (JP); Naoki TOYOFUKU, Toyota-shi (JP); Kenji FUKUCHI, Toyota-shi (JP)

(73) Assignees: TOYOTA JIDOSHA KABUSHIKI KAISHA, Toyota-shi (JP); FUJITSU TEN LIMITED, Kobe-shi (JP)

(21) Appl. No.: 13/287,547

(22) Filed: Nov. 2, 2011

(30) Foreign Application Priority Data
Nov. 10, 2010 (JP) 2010-251954

(51) Int. Cl. G11B 31/00

(52) U.S. Cl. 369/21; G9B/31

(57) ABSTRACT

A CAN driver receives vehicle information sent onto CAN. A diagnosis information acquiring module monitors whether an operation of a diagnosis record ECU itself is normal or not and thus generates diagnosis information. A timestamp information generating module generates timestamp information A per sec and generates timestamp information B in which a time difference from the generation timing of the timestamp information A is expressed on the unit of 1/100 sec. A diagnosis record module, each time the timestamp information generating module generates the timestamp information A, transfers a first type record containing the timestamp information A and the diagnosis information generated at this point of time to a memory manager, and transfers a second type record containing the vehicle information and the timestamp information B generated at this point of time to the memory manager.

### CROSS-REFERENCE TO RELATED APPLICATIONS

This application is based upon and claims the benefit of priority of the prior Japanese Patent Application No. JP2010-251954, filed on Nov. 10, 2010, the entire contents of which are incorporated herein by reference.

### FIELD

The present invention relates to a recording device which records various items of information received via an on-vehicle network.

### BACKGROUND

A vehicle such as a car at the present, which undergoes acceleration of unitizing electronic components, adopts in many cases a configuration of connecting, in a mutual communication-enabled manner via an on-vehicle network such as CAN (Controller Area Network), ECUs (Electronic Control Units) for controlling the respective electronic components, sensors for detecting items of status information (e.g., an acceleration, a throttle aperture, an exhaust gas temperature, an O₂ concentration, details of operations of a variety of switches, etc) inputted to the respective ECUs and an actuator for driving the electronic control component according to control information given from each ECU. There is a data recording device as one type of these ECUs.

The data recording device is the ECU which intercepts the status information and control information which flow on the on-vehicle network and result information of abnormality diagnosis by each ECU itself (diagnosis information such as a diagnosis code) (these items of information will hereinafter be generically termed [vehicle information]) and records the vehicle information on a predetermined nonvolatile storage medium. The vehicle information recorded on the nonvolatile storage medium by this data recording device is read by an off-vehicle inspection device (computer) when inspecting and repairing the vehicle, thereby diagnosing the sensors themselves and machine parts about faults and also the ECUs about whether an abnormal state exists or not and analyzing a cause of the fault.

The vehicle information recorded on the nonvolatile storage medium is required to be recorded as information for making the abnormality diagnosis and analyzing the cause in the way of being associated with vehicle information generation time (timestamp) in order to know a generation sequence and generation timing of the vehicle information. Further, for properly conducting the diagnosis, it must be assured that the vehicle information recorded on the nonvolatile storage medium by the data recording device is identical with the vehicle information circulated on the on-vehicle network. Namely, it must be assured that the data recording device itself operated normally. For this assurance, the data recording device itself is provided with a diagnosis function of detecting whether the operation of the self-ECU is normal or not, and diagnosis information (information indicating whether the operation, detected by the diagnosis function, of the self-ECU is normal or not) about the self-ECU may be stored on the nonvolatile storage medium in the way of being associated with the vehicle information.

FIG. 14 is a format diagram of a record containing descriptions of the vehicle information and the diagnosis information. In FIG. 14, [CANID] is identification information for distinguishing the vehicle information from others in a case where the on-vehicle network is CAN, [timestamp information A (day/hour/min/sec)] is information indicating a day, hours, minutes and seconds representing the time when the vehicle information and the diagnosis information are obtained, [timestamp information B ( 1/100 sec)] is a value ( 0/100- 99/100) with which fractions less than one sec representing the time are expressed on the unit of 1/100 sec, [data] is the vehicle information, and [SUM] is a checksum value.

Moreover, FIG. 15 is a conceptual diagram which conceptually illustrates a status of accumulating such a plurality of records on the nonvolatile storage medium. In FIG. 15, “OK” and “NG” are values of the [diagnosis information].

[Patent document 1] Japanese Patent Application Laid-Open Publication No. 2007-213393

### SUMMARY

If all of the records are configured to record the detailed timestamp information (e.g., both of the timestamp information A [day/hour/min/sec] and the timestamp information B [ 1/100 sec]), however, such a problem arises that a data size of one record increases and the nonvolatile storage medium easily undergoes an overflow.

Further, in the case of generating and accumulating the records described above when receiving the vehicle information and if disabled from normally executing a process of receiving the vehicle information due to, e.g., occurrence of abnormality in the data recording device itself, it follows that the record is not generated.

Namely, even when providing the data recording device with the diagnosis function, there is a possibility of occurrence of such a phenomenon that the diagnosis result thereof is not recorded as the record.

Such being the case, it is an object of the present invention to provide an information recording device capable of reducing a data size of one record on the occasion of recording in such a case that the record target information circulated on the network is recorded including the timestamp information.

Moreover, another object (additional object) of the present invention lies in gasping a status (a status where the vehicle information is not recorded due to the occurrence of the abnormality in the device itself) by analyzing the registered records even if the abnormality occurs in the device itself.

An information recording device according to the present invention, which records predetermined record target information in data transmitted to a network from a variety of ECUs and a variety of sensors, includes: communication means receiving the record target information from the network; timestamp information generating means generating absolute timestamp information and relative timestamp information in which differential time from the absolute timestamp information expressed by a data size smaller than a data size of the absolute timestamp information; recording data generating means generating first recording data containing present absolute timestamp information at intervals of predetermined time, and generating second recording data containing the record target information and the relative timestamp information each time the communication means receives the record target information; and record processing means recording, on a recording medium, the first recording data and the second recording data each generated by the recording data generating means in a way that arranges these items of recording data in a recording data generating sequence.

If thus configured, in the case of recording the record target information received from on the network, the absolute timestamp information is not recorded in the second recording data recorded with the record target information, and hence an overall length of the recording data can be reduced.

As for the unit of the absolute timestamp information and the unit of the relative timestamp information, the former unit may be based on a day, hours, minutes and seconds, while the latter unit may be smaller than the former unit; or alternatively the former unit is based on the day, hours and minutes, while the latter unit may be the seconds. Moreover, a phase of generating the absolute timestamp information may be just the time indicated by the unit of the absolute timestamp information and may also be deviated by a fixed period of time from the just time.

The network may be an on-vehicle network and may also be a network for controlling other machines. In the former case, the network may be CAN and may also be an on-vehicle network based on another protocol.

According to the present invention having the configuration described above, it is feasible to reduce the data size of the record registered with the record target information on the occasion of recording, on the recording medium, the record target information circulated on the network.

### BRIEF DESCRIPTION OF THE DRAWINGS

FIG. 1 is a block diagram illustrating an outline of architecture of an on-vehicle network system including a data recording device;

FIG. 2 is a diagram of a software configuration, illustrating a variety of programs executed by a microcomputer of the data recording device and various items of information on a RAM;

FIG. 3 is a data flowchart illustrating a flow of data processing based on each program;

FIG. 4 is a format diagram of CAN data;

FIG. 5 is a format diagram of a time data record stored with diagnosis information;

FIG. 6 is a format diagram of a modified example of the time data record;

FIG. 7 is a format diagram of a CAN data record stored with vehicle information;

FIG. 8 is a format diagram of a group of records accumulated in a record accumulation buffer and a storage element at a normal time;

FIG. 9 is a format diagram of a group of records accumulated in the record accumulation buffer and the storage element at an abnormal time;

FIG. 10 is a flowchart illustrating a transfer process to a recording data generating unit of a CAN communication control unit;

FIG. 11 is a flowchart illustrating a process of the recording data generating unit;

FIG. 12 is a flowchart illustrating a transfer process to a write buffer of a memory manager;

FIG. 13 is a flowchart illustrating a transfer process to a storage device control unit of the memory manager;

FIG. 14 is a format diagram of the record in the case of writing the vehicle information and the diagnosis information in the same record; and

FIG. 15 is a diagram of a data structure of a data file in the case of writing the vehicle information and the diagnosis information in the same record.

### DESCRIPTION OF EMBODIMENTS

A mode for carrying out the present invention will hereinafter be described on an exemplifying and not-limiting basis with reference to the drawings. An embodiment, which will hereinafter be discussed, is an exemplification, and the present invention is not limited to the embodiment.

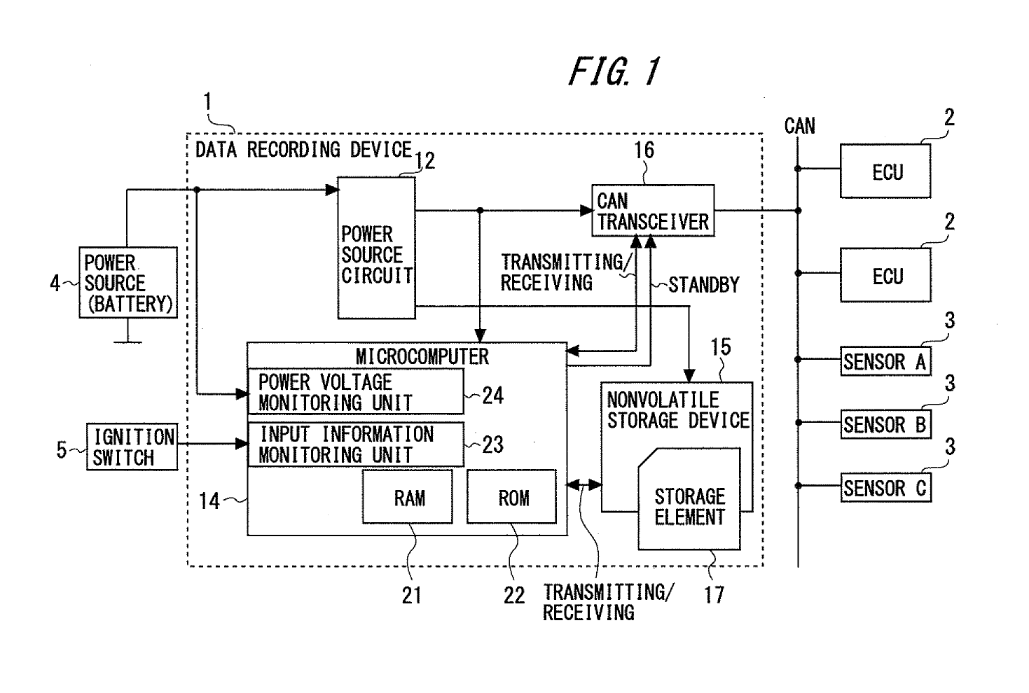

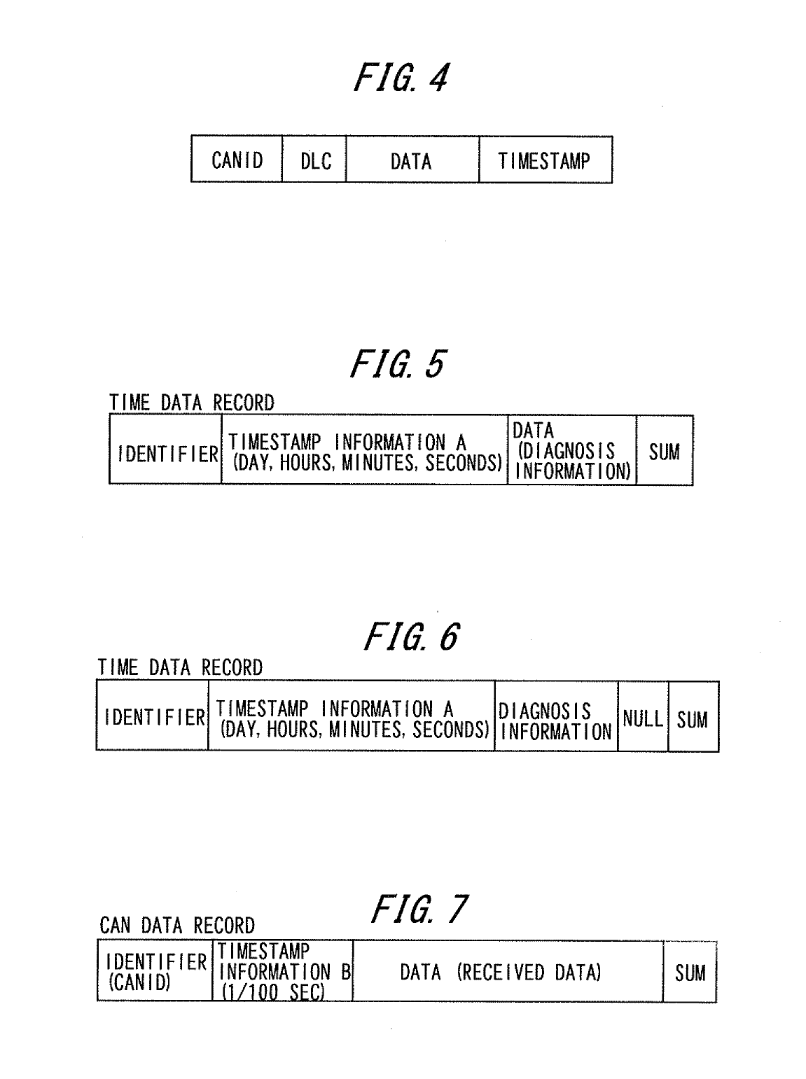

FIG. 1 is a block diagram illustrating an outline of architecture of an on-vehicle network system including a data storage device (corresponding to an information storage device) according to the embodiment. As depicted in FIG. 1, a variety of ECUs (Electronic Control Units) 2 for controlling respective electronic components (an actuator, meters, etc) of a vehicle and a variety of sensors 3 for detecting states of the vehicle, are connected in a mutual communication-enabled manner by a CAN (Controller Area Network) categorized as one type of on-vehicle network. Herein, the variety of ECUs 2 include an engine control ECU, an ABS (Antilock Brake System) ECU, etc. Further, the variety of sensors include an acceleration sensor, an exhaust gas temperature sensor, an O₂ sensor, various switches and pedals. Each of these various ECUs 2 and sensors 3 stores data addressed to another ECU 2 in a predetermined-formatted frame (FIG. 4) and sends this frame to the CAN. The frame, which is thus transmitted to the CAN (which will hereinafter be referred to as [CAN data]), is captured by the ECU 2 requiring this frame and is used for the ECU 2 to control the electronic components.

The data storage device 1 is the ECU for intercepting the CAN data containing vehicle information (control information and state information) in pieces of CAN data that are thus circulated on the CAN and storing the intercepted data in a storage element 17 in preparation for a fault inspection conducted another day and is therefore connected to the CAN in the same way as other ECUs 2 are. Herein, the CAN is one type of on-vehicle network, however, determination as to what type of on-vehicle network the ECUs are connected via is made depending on a required data bandwidth and a required cost. Accordingly, if there exists the ECU connected to another type of on-vehicle network (e.g., LIN [Local Interconnect Network], FlexRay [registered trade mark of Daimler AG]) it is desirable that the data storage device 1 is connected also to this another type of on-vehicle network.

The data storage device 1 includes, as built-in components, a CAN transceiver 16 serving as an interface with the CAN, a microcomputer 14 which executes processing the CAN data, a nonvolatile storage device 15 connected to the microcomputer 14 and, in addition, a power source circuit 12 for supplying the microcomputer 14 and the nonvolatile storage device 15 with electric power from a power source (battery) 4 in a way that steps down the voltage. Note that the nonvolatile storage device 15 uses the storage element configuring a storage area by a nonvolatile storage element, whereby the data can be retained even when the power source is cut off, and besides a backup RAM may be configured to retain the data by supplying a volatile memory (RAM) with the electric power for memory retention even when the power source is cut off. Further, the nonvolatile storage device 15 may also adopt a configuration of being built in the microcomputer 14.

The CAN transceiver 16, which is a device to terminate a physical layer of the CAN, converts the CAN data modulated by a two-wire operating voltage system on the CAN into binary signals of H/L and thus transmits the converted binary signals to the microcomputer 14.

The microcomputer 14 includes, as hardware components, in addition to an unillustrated processor which executes a program, a RAM (Random Access Memory) 21 and a ROM (Read Only Memory) 22. Moreover, an input information monitoring unit (module) 23 is defined as a function of monitoring statuses (ON/OFF) of an ignition signal inputted to other ECUs from an ignition switch 5 and inputting a monitoring result to the processor. Further, a power voltage monitoring unit (module) 24 is a function of monitoring a voltage of the power source (battery) 4 while the processor is kept in a wakeup status and inputting a monitoring result to the processor. These respective functions are those realized by the processor in a way that executes the program. Note that the data recording device 1 is connected directly to the battery neither via the ignition switch nor via an accessory switch and is therefore supplied with the power during the OFF-status of the ignition switch. This configuration mainly intends to retain the data in the RAM 21. Then, a process of recording the data in the RAM 21 is executed during only the ON-status of the ignition switch, and a standby status (power save mode) is set during the OFF-status of the ignition switch. The configuration may, however, be modified so that the data is recorded in the RAM 21 also during the OFF-status of the ignition switch.

The ROM 22 is stored with a variety of programs that are read and executed by the processor.

The RAM (corresponding to a volatile memory) 21 is an operation area in which a variety of buffers are configured by the processor executing processes based on the various programs.

A storage area of the storage element (corresponding to a nonvolatile memory) 17 is configured by a nonvolatile storage element.

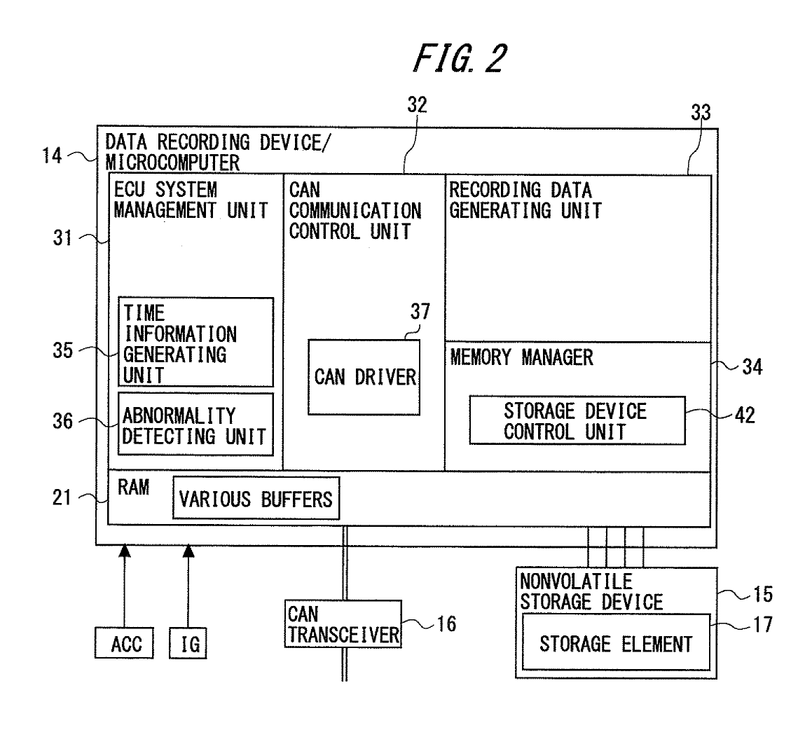

FIG. 2 is a diagram of a software configuration, illustrating respective functions realized by the processor executing the programs stored in the ROM 22. As depicted in FIG. 2, the functions realized by the processor are roughly classified into, in addition to the respective functions 23, 24 described above, an ECU system management unit 31, a CAN communication control unit 32, a recording data generating unit 33 and a memory manager 34.

The ECU system management unit (module) 31 is a function of controlling the individual circuits configuring the data storage device 1 and includes, as subordinate units thereunder, a timestamp information generation unit 35 and an abnormality detection unit 36.

The timestamp information generation unit 35 is a software timer for managing the present time by counting up the time, and generates timestamp information A (absolute timestamp information) indicating the present time on the unit of day/hour/min/sec (on a predetermined unit) at timing (at intervals of 1 sec) when timestamp information B overflows as well as generating the timestamp information B (relative timestamp information) indicating a time difference from just every second at the present time on the unit of 1/100 sec ( 0/100 sec- 99/100 sec) at intervals of 1/100 sec. The following discussion will be made on the premise that a data size of the timestamp information A is larger than a data size of the timestamp information B, however, the premise is not necessarily limited to a relation such as this. The timestamp information generation unit 35, immediately when generating the timestamp information A, transmits the timestamp information A to the recording data generating unit 33. Further, the timestamp information generation unit 35, when requested by the recording data generating unit 33, sends the timestamp information B to the recording data generating unit 33 (corresponding to timestamp information generating means).

The abnormality detection unit (module) 36 is a function of executing a self-diagnosis of the data recording device 1 and notifying the recording data generating unit 33 of a diagnosis result as diagnosis information. For example, the abnormality detection unit 36, if the CAN communication control unit 32 does not output the data to the recording data generating unit 33 for a predetermined period of time or longer, determines that the CAN communication control unit 32 is in an abnormal status. Furthermore, the abnormality detection unit 36 detects the abnormality by checking the write and the read to and from the various buffers (corresponding to an abnormality detecting means).

Further, the ECU system management unit 31, which manages transitions between a wakeup status and a sleep status of the whole microcomputer 14, causes the whole microcomputer 14 to transition to the sleep status after completing the necessary processes based on other programs if the monitoring result of the input information monitoring unit 23 is the OFF-status of the ignition signal and, while on the other hand, causes the whole microcomputer 14 to transition to the wakeup status if the monitoring result of the input information monitoring unit 23 is checked even when in the sleep status and indicates the ON-status of the ignition signal.

Note that the timestamp information generation unit 35 executes the process of counting up the timer also when in the sleep status, thereby continuously managing the present time also when in the sleep status.

The can communication control unit 32 terminates a logical layer of a CAN protocol and executes a process for the CAN data transmitted from the CAN transceiver 16 by use of a CAN driver 37.

The recording data generating unit 33 aggregates the vehicle information transferred from the CAN communication control unit 32, the diagnosis information transferred from the abnormality detection unit 36 and the timestamp information A and the timestamp information B each transferred from the timestamp information generation unit in a predetermined format, and transfers the thus-aggregated information to the memory manager 34 (corresponding to recording data generating means).

The memory manager 34 accesses the storage element 17 by employing a storage device control unit 42 and writes the data (corresponding to storage processing means).

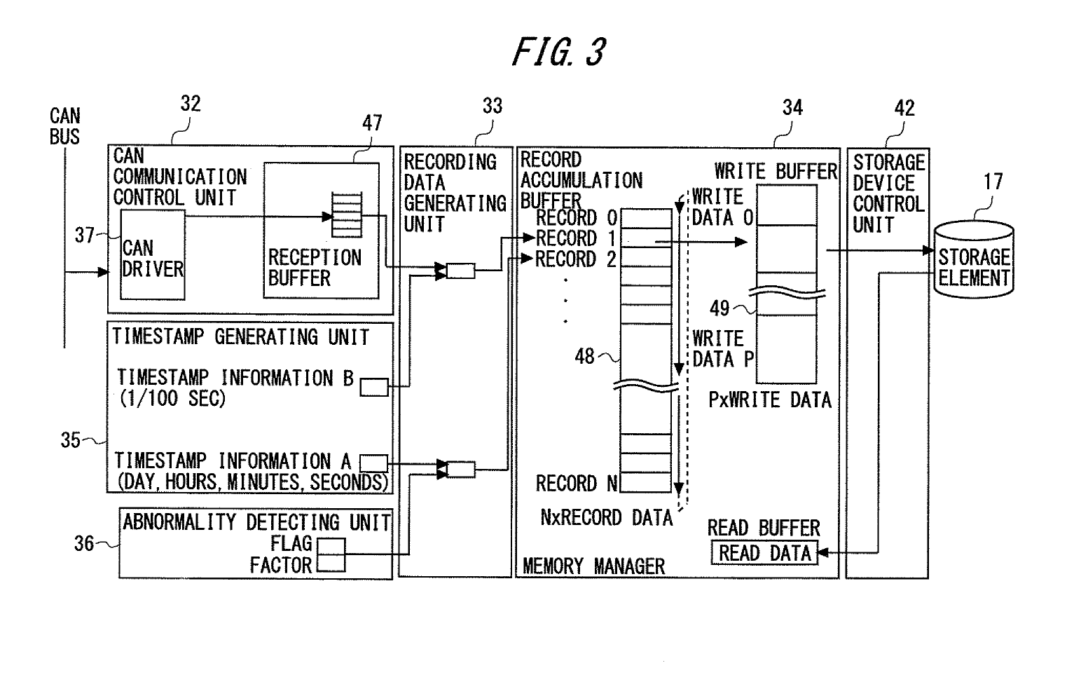

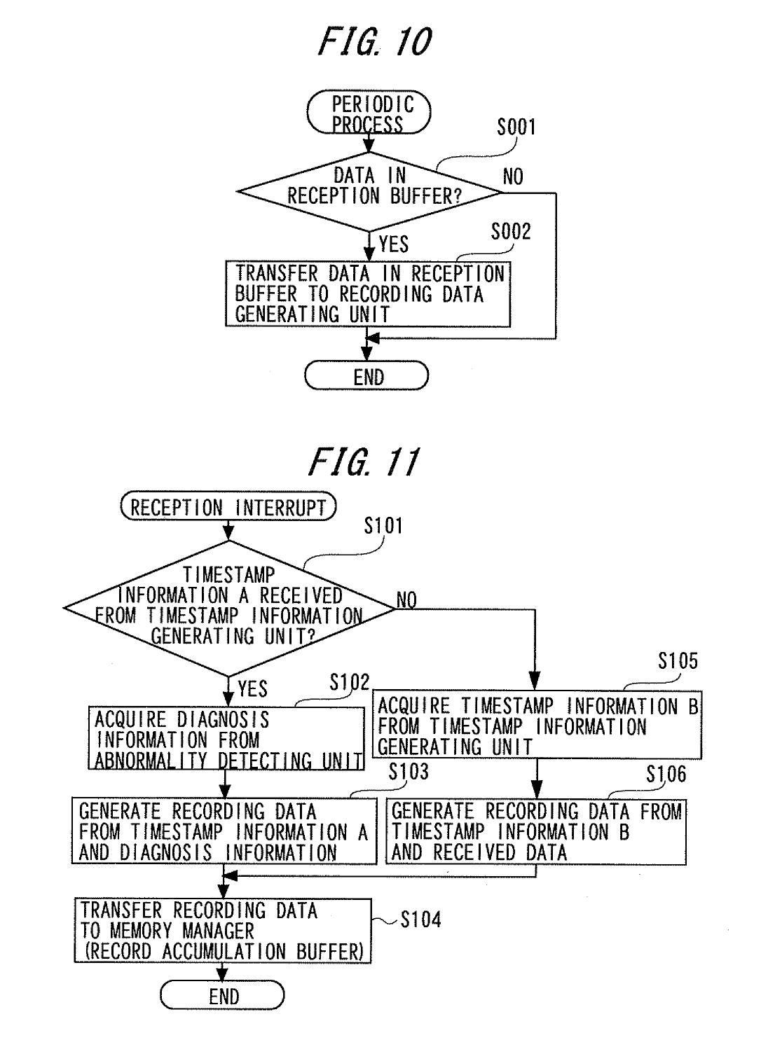

Contents of the specific processes for the respective items of data based on the functions described above will hereinafter be explained with reference to a data flowchart of FIG. 3, format diagrams of FIGS. 5 through 9 and flowcharts of FIGS. 10 through 13. Note that the write data in a writing buffer 49 and read data in a reading buffer are what plural items of record data are aggregated in FIG. 3. Further, the format diagrams of FIGS. 5 through 9 illustrate one examples of the format, and the contents of the format may be modified.

To start with, as schematically depicted in the format diagram of FIG. 4, the CAN data contains a [CANID] field stored with CANID, a [data] field stored with circulation target data, a [DLC] field stored with a description of a byte length given in the [data] field and a [timestamp] field stored with a description of a timestamp when issuing CAN data.

Then, the CAN communication control unit 32 stores, in a reception buffer 47, the CAN data transmitted from the CAN transceiver 16 any time by using the CAN driver 37. On the other hand, the CAN communication control unit 32, as illustrated in FIG. 10, periodically checks whether the CAN data is stored in the reception buffer 47 or not (S001) and transfers, as far as the CAN data exists in the reception buffer, the CAN data in the reception buffer 47 to the recording data generating unit 33 (S002).

The recording data generating unit 33 makes an interrupt-start of the process illustrated in FIG. 11 whenever receiving the CAN data transferred from the CAN communication control unit 32 and whenever receiving the timestamp information A from the timestamp information generation unit 35. Then, in first step S101 after the start, the recording data generating unit 33 checks whether the CAN data or the timestamp information A is received.

Then, in the case of receiving the timestamp information A from the timestamp information generation unit 35, the recording data generating unit 33 acquires the diagnosis information from the abnormality detection unit 36 in S102.

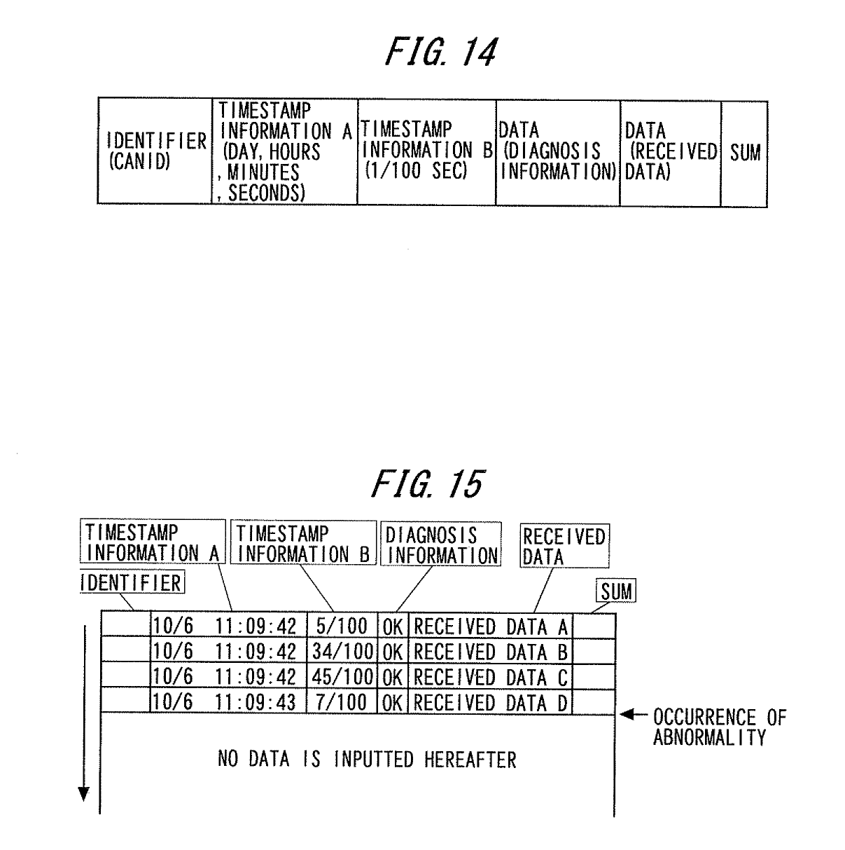

In next step S103, the recording data generating unit generates data for recording from the timestamp information A acquired from the timestamp information generation unit 35 and the diagnosis information acquired from the abnormality detection unit 36. The recording data is defined as a record consisting of, as depicted in the format diagram of FIG. 5, items of data in the [identifier (CANID)] field stored with CANID, the [timestamp information] field stored with the timestamp information A, the [data (diagnosis information)] field stored with the diagnosis information and the [SUM] field stored with a value of checksum. Note that the [data (diagnosis information)] field may be, as depicted in the format diagram of FIG. 6, subdivided into a [diagnosis information] field indicating Normal (OK)/Abnormal (NG) and a [Null] field. In this case, the [Null] field may be stored with pieces of information representing an abnormality classification, a factor of the abnormality, etc. After a completion of S103, the recording data generating unit 33 advances the processing to S104. Note that the formats illustrated in FIGS. 5 and 6 have, as apparent from a comparison between FIG. 5, FIG. 6 and FIG. 14, a less number of fields than the fields of the format illustrated in FIG. 14, and hence the data size of each of the formats depicted in FIGS. 5 and 6 is smaller than in FIG. 14. On the occasion of applying the invention of the present application, however, the formats are not necessarily limited to those having the relation between the data sizes such as this.

On the other hand, when determining 5101 that the CAN data transferred from the CAN communication control unit 32 is received, the recording data generating unit 33 acquires the timestamp information B from the timestamp information generation unit 35 in S105.

In next step S106, the recording data generating unit 33 generates the recording data from the CAN data received from the CAN communication control unit 32 and the timestamp information B acquired from the timestamp information generation unit 35. The recording data is defined as a record consisting of, as depicted in the format diagram of FIG. 7, items of data in the [identifier (CANID)] field stored with CANID, the [timestamp information] field stored with the timestamp information B, the [data] field stored with the circulation target data in the CAN data and the [SUM] field stored with the value of checksum. After a completion of S106, the recording data generating unit 33 advances the processing to S104. Note that the format illustrated in FIG. 7 has, as apparent from a comparison between FIG. 7 and FIG. 14, a less number of fields than the fields of the format illustrated in FIG. 14, and hence the data size of the format depicted in FIG. 7 is smaller than in FIG. 14. Further, the data size of the format illustrated in FIG. 7 is equal to the data size of each of the formats illustrated in FIGS. 5 and 6. On the occasion of applying the invention of the present application, however, the formats are not necessarily limited to those having the relation between the data sizes such as this.

In S104, the recording data generating unit 33 transfers the recording data generated in S103 or S106 to the memory manager 34 to store the data in a buffer 48 for accumulating the records.

The memory manager 34, whenever receiving the recording data transferred from the recording data generating unit 33, stores (overwrites)) in a cyclic sequence the received recording data in the record accumulation buffer 48 capable of storing N-pieces of records in a ring format.

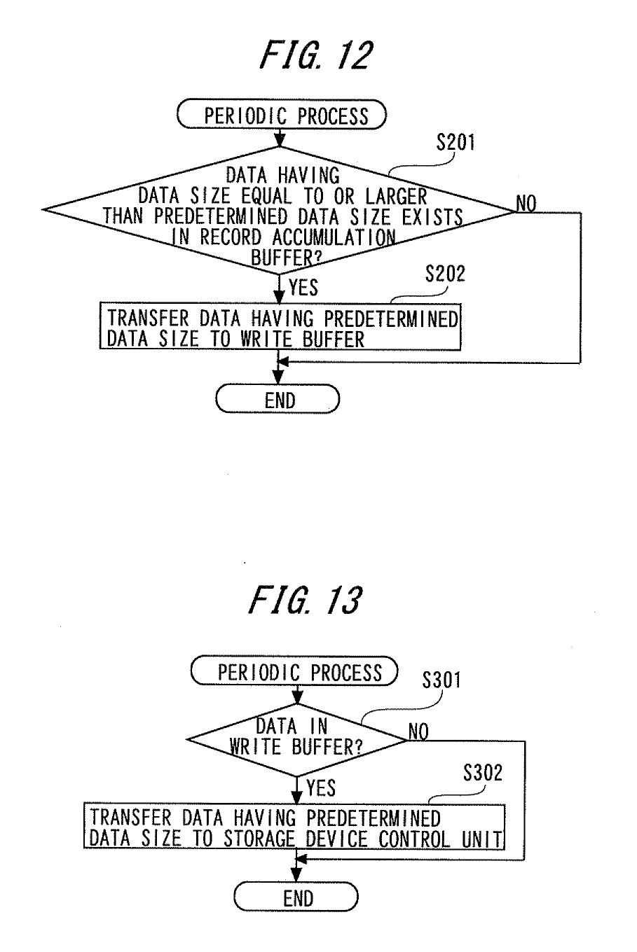

Further, the memory manager 34, as illustrated in FIG. 12, periodically checks whether or not the record accumulation buffer 48 is stored with the recording data of which the data size is equal to or larger than a predetermined quantity (data size), i.e., a maximum data size with which the storage device control unit 42 can write the data to the storage element 17 in one writing process (S201), and transfers, only when stored with the recording data of which the data size is equal to or larger than the predetermined data size, the recording data having the predetermined data size to the writing buffer 49 (S202).

Moreover, the memory manager 34, as illustrated in FIG. 13, periodically checks whether or not the writing buffer 49 is stored with the recording data (S301), and transfers, only when the writing buffer 49 is stored with the recording data, the data having the predetermined data size stored in the writing buffer 49 to the storage device control unit 42 (S302).

The storage device control unit 42 accumulates, in the storage device element 17, the recording data transferred from the memory manager 34 in the transfer sequence (i.e., in the sequence of being generated by the recording data generating unit 33).

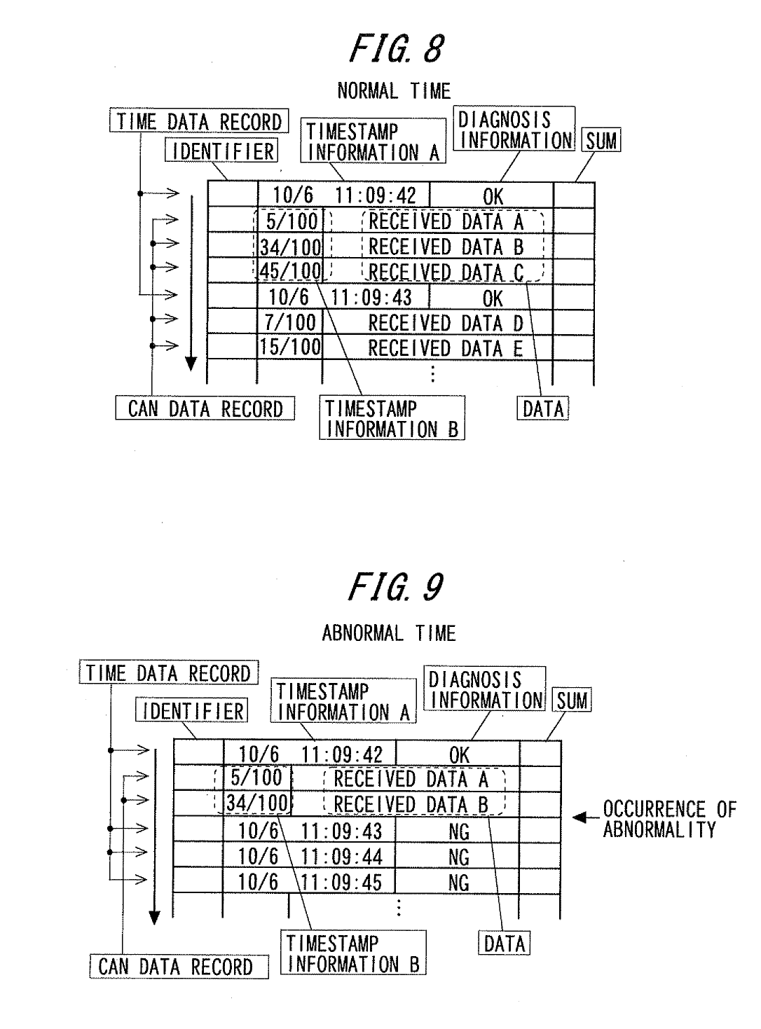

According to the embodiment discussed so far, at the normal time when the abnormality detection unit 36 does not detect any abnormal state, the status of the data accumulated in the storage device element 17 becomes logically what is illustrated in FIG. 8. Each of rows in FIG. 8 indicates each record of recording data, in which the latest record is generated at the newest generation timing toward the lowest row from the highest row. Therefore, in the status of accumulating the recording data, such a mode is taken that several items of recording data containing the timestamp information B and the circulation target data in the CAN data, which are generated in S104 for the periods of time indicated by pieces of timestamp information A in the recording data, are inserted in between the records of recording data containing the timestamp information A and the diagnosis information that are generated in S103 just at every second irrespective of whether the CAN data is received or not. Moreover, at the abnormal time when the abnormality detection unit 36 detects the abnormal state, the accumulation status of the recording data becomes what is illustrated in FIG. 9.

As obvious from the comparison between FIGS. 8, 9 and 15, according to the embodiment, the diagnosis information of the data storage device 1 itself is recorded just at every second regardless of whether the CAN data is received or not, however, the vehicle information is recorded in an independent record each time this information is received, and hence there is no necessity for recording the diagnosis information and the vehicle information in the same record (row).

Further, according to the embodiment, each record of recording data, which is stored with the CAN data, does not contain the information on [day/hour/min/sec] but contains the timestamp information B indicating the time difference from just every second, and therefore the timing (≈CAN data generation timing) when the recording data is obtained can be computed by adding the timestamp information B in the recording data to the timestamp information A existing just anterior thereto. Hence, there is no necessity for storing the information on [day/hour/min/sec] in the recording data stored with the CAN data. In addition, it is not required that the timestamp information B is stored in the recording data stored with the timestamp information A and the diagnosis information.

Incidentally, another available scheme is that the timestamp information B is contained in the timestamp information of the recording data stored with the timestamp information A and the diagnosis information.

What has discussed so far enables the data size of each record of recording data to be reduced. Then, generally an average data count per sec of the CAN data of the vehicle information circulated on the on-vehicle network is by far larger than “12”. Therefore, according to the embodiment, the total data count of the recording data becomes larger than by the conventional technique by a quantity of the diagnosis information stored in the independent recording data separately from the CAN data, and nevertheless the total data size is reduced to a more sufficient degree than by the conventional technique.

Note that the diagnosis information of the data storage device 1 itself is recorded in the same location as other items of recording data (vehicle information) are recorded according to the embodiment, and it is therefore desirable in terms of facilitating the analysis of the recording data (vehicle information).

It should be noted that CAN is used also for controlling machines other than the vehicle, and the problem set as the premise by the present invention might arise also in the case of using CAN other than the vehicle and might also arise in the case of utilizing the on-vehicle network other than CAN Hence, the present embodiment maybe applied to these cases. Moreover, the embodiment is configured to change the operation corresponding to the status of the ignition switch 5 etc, however, the invention is not necessarily limited to the configuration of being triggered by the status of the switch or the like such as this on the occasion of detecting whether in the status where the vehicle information should be recorded or not. For example, in the vehicle such as an electric vehicle and a fuel cell vehicle performing some operation such as charging the vehicle with electricity during parking, the start and the stop of recording the data may be controller corresponding to a control signal given from the ECU which handles the control of the vehicle. For others, the system architecture of the data storage device 1 may be properly modified within the scope in which the invention of the present application can be materialized.

What is claimed is:

1. An information recording device recording predetermined record target information in data transmitted to a network from a variety of ECUs and a variety of sensors, said device comprising:
communication means receiving the record target information from the network;
timestamp information generating means generating absolute timestamp information and relative timestamp information in which differential time from the absolute timestamp information expressed by a data size smaller than a data size of the absolute timestamp information;
recording data generating means generating first recording data containing present absolute timestamp information at intervals of predetermined time, and generating second recording data containing the record target information and the relative timestamp information each time said communication means receives the record target information; and
record processing means recording, on a recording medium, the first recording data and the second recording data each generated by said recording data generating means in a way that arranges these items of recording data in a recording data generating sequence.

2. An information recording device recording predetermined record target information in data transmitted to a network from a variety of ECUs and a variety of sensors, said device comprising:
communication means receiving the record target information from the network;
abnormality detecting means making a self-diagnosis as to whether an operation of said information recording device itself is normal or not and generating diagnosis information representing a diagnosis result;
timestamp information generating means generating absolute timestamp information and relative timestamp information in which differential time from the absolute timestamp information expressed by a data size smaller than a data size of the absolute timestamp information;
recording data generating means generating first recording data containing present absolute timestamp information and the diagnosis information at intervals of predetermined time, and generating second recording data containing the record target information and the relative timestamp information each time said communication means receives the record target information; and
record processing means recording, on a recording medium, the first recording data and the second recording data each generated by said recording data generating means in a way that arranges these items of recording data in a recording data generating sequence.

3. The information recording device according to claim 2, wherein the record target information contains the diagnosis information defined as results of abnormality diagnosis made by said variety of ECUs, which are transmitted to the network from the variety of ECUs.

4. The information recording device according to claim 1, wherein said communication means, when receiving the record target information, transmits the received record target information to said recording data generating means,
said timestamp information generating means generates the absolute timestamp information at cycles of the predetermined time and transmits the thus-generated absolute timestamp information to said recording data generating means, and
said recording data generating means generates the first recording data at timing when said timestamp information generating means transmits the absolute timestamp information, and generates the second recording data at timing when the record target information is transmitted from said communication means.

5. The information recording device according to claim 1, wherein the timing when said timestamp information generating means generates the absolute timestamp information is timing when a change occurs in a value of the lowest order in the absolute timestamp information.
